(19) United States
(12) Patent Application Publication
(10) Pub. No.: US 2011/0214917 A1
(43) Pub. Date: Sep. 8, 2011

(54) Power Swivel Stand Having Pivoting Positioning Arms

(75) Inventor: Raleigh J. Boudreaux, Opelousas, LA (US)

(73) Assignee: PROFESSIONAL WIRELINE RENTALS, LLC, Broussard, LA (US)

(21) Appl. No.: 12/879,626

(22) Filed: Sep. 10, 2010

Related U.S. Application Data
(60) Provisional application No. 61/241,877, filed on Sep. 12, 2009.

(51) Int. Cl. E21B 19/00; F16M 11/18

(52) U.S. Cl. 175/52; 248/157

(57) ABSTRACT

A power swivel stand for horizontally and vertically positioning a power swivel with respect to a well being serviced. A frame is mounted on a base, preferably by pinned connections. A carriage is mounted in the frame and is vertically positioned by one or more hydraulic cylinders. Attached to the carriage are one or more positioning arms, in such a manner that the positioning arms can be pivoted in a vertical plane. The positioning arms can be pivoted by extension and retraction of hydraulic cylinders connecting the carriage and the positioning arms. A power swivel is held by the positioning arms. Pivoting the positioning arms moves the power swivel horizontally into and out of alignment with the well being serviced.

### CROSS REFERENCE TO RELATED APPLICATIONS

This regular United States patent application claims priority to U.S. provisional patent Ser. No. 61/241,877, filed Sep. 12, 2009, for all purposes.

### BACKGROUND

This invention relates, generally, to apparatus used in connection with the servicing of boreholes drilled in the earth, such as oil and gas wells, referred to herein as “wells.” More specifically, this invention relates to apparatus used to position and manipulate a power swivel and related equipment on an offshore structure, particularly (although not exclusively) used in connection with the abandonment of oil and gas wells.

Oil and gas wells, particularly offshore oil and gas wells, pose a significant liability when such wells are in need of plugging and abandonment. Many of such wells were drilled from a fixed platform, on which a drilling rig was at one time mounted. Others are positioned within a fixed platform but were initially drilled by other means. Regardless of the mode of drilling, many of such wells were completed and flowed to production facilities on the fixed structure. Typically, conductor pipe, along with multiple casing strings, extend up above the surface of the water to a deck on the fixed structure.

When it is desired to plug and abandon the wells, the multiple tubular strings—tubing, casing, etc.—must be cut at a suitable distance below the ocean floor and pulled out. This tubular cutting generally involves the use of a tubular string (which for purposes of this application will be referred to as a “drillstring,” with that term used broadly and encompassing any form of tubular string used in connection with such work), on which are run various downhole tools, such as cutters, spears, etc. The drillstring is manipulated (rotated, reciprocated, etc.), and along with fluids pumping cuts the tubulars. Then, the tubulars above the cut must be pulled out of the wellbore, the joints thereof unscrewed and laid down on the deck of the structure.

While a rig could be placed on the structure to carry out such work, use of a rig for this work would be quite expensive. A significant incentive exists to use equipment and methods which are capable of handling the drillstring and cutting the casing strings, without requiring mobilization of a rig. Certain existing apparatus and methods use a hydraulic motor driven power swivel, in conjunction with power tongs. It can be appreciated that the power swivel must be positioned or moved both vertically and horizontally with respect to the well. Vertical movement of the power swivel is necessary to place downhole cutting tools and the like at the desired depth. Horizontal movement of the power swivel is required to move it out of vertical orientation with the well, so that tubulars can be run into or pulled from the well, or so that power tongs can be moved into position to make or break threaded connections, etc. One prior art apparatus and method employs a work deck which is positioned over a well to be worked on, with a frame carrying the power swivel slidably mounted on the work deck. Vertical positioning of the power swivel (which is mounted to a vertically movable carriage) is accomplished by vertically-oriented hydraulic cylinders. Horizontal positioning of the power swivel is accomplished by sliding the frame, relative to the work deck, via a track and horizontal hydraulic cylinder arrangement. Thus, the entirety of the frame, carriage and power swivel must be moved horizontally into and out of position directly over the well to be worked on, see U.S. Pat. No. 7,527,100.

### SUMMARY

In a power swivel stand embodying the principles of the present invention, a means for horizontally positioning the power swivel without horizontal movement of the frame with respect to the base is provided. The means for horizontally positioning the power swivel without horizontal movement of the frame with respect to the base may comprise a plurality of pivoting positioning arms connected to a carriage.

In a presently preferred embodiment, the power swivel is moved horizontally by pivoting one or more positioning arms carrying the power swivel, while the frame remains stationary with respect to the base on which it is mounted. A carriage is mounted in the frame and vertically movable therein. The positioning arms are pivotally mounted to the carriage, and a means for pivoting the positioning arms rotates them in a vertical plane; in one embodiment, the means for pivoting the positioning arms comprises one or more hydraulic cylinders connected between the carriage and the positioning arms, where extension and retraction of the hydraulic cylinders pivots the positioning arms. The power swivel is mounted on the positioning arms. Vertical positioning of the power swivel is achieved primarily by vertical positioning of the carriage, by a means for vertically positioning same; pivoting the positioning arms moves the power swivel horizontally into and out of alignment with the well being serviced.

### BRIEF DESCRIPTION OF THE DRAWINGS

FIG. 1 is a perspective view of a power swivel positioner embodying the principles of the invention, in an operating position.

FIG. 2 is a side view of the power swivel positioner.

FIG. 3 is another side view of the power swivel positioner, with the power swivel in a lowered position.

FIG. 4 is another side view of the power swivel positioner, with the power swivel in a raised position.

FIG. 5 is a more detailed view of the positioning arms, carriage and related components.

FIG. 6 is a view of the apparatus in a collapsed position.

FIGS. 7-9 show an alternate embodiment, having a rack and pinion gear system for vertical positioning of the carriage.

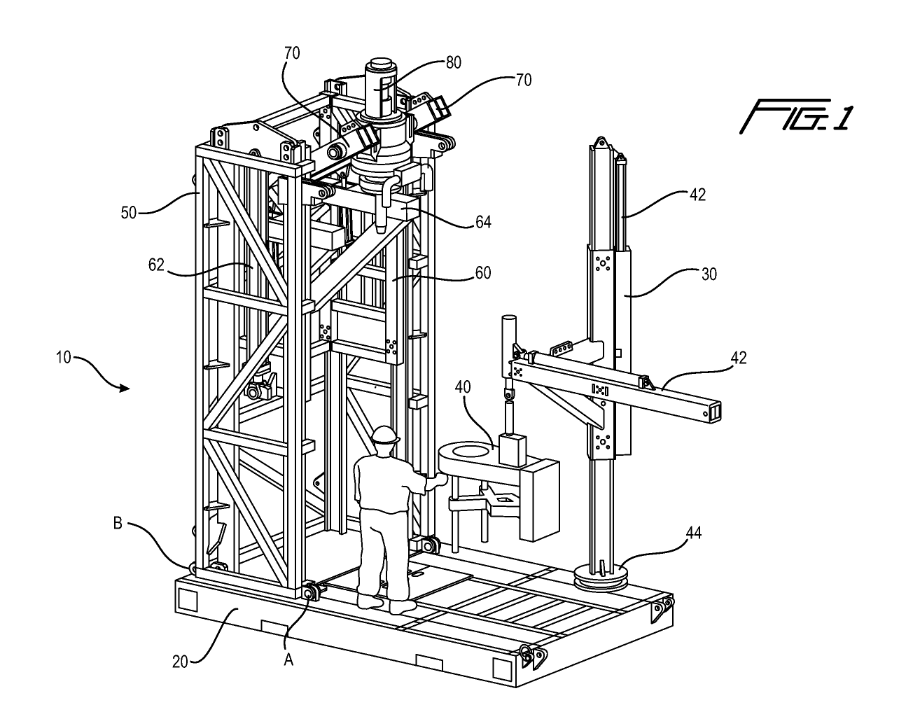

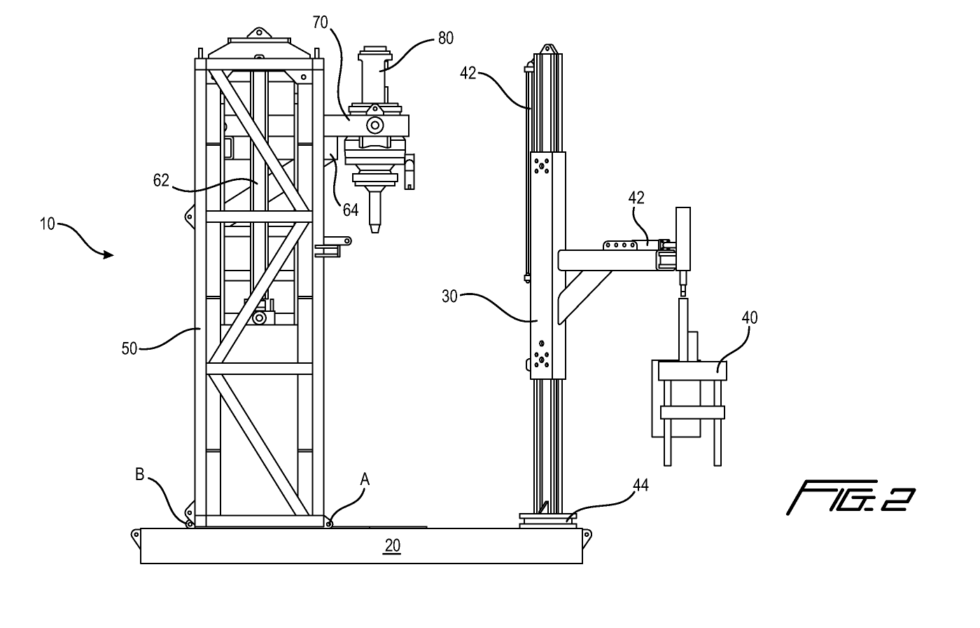

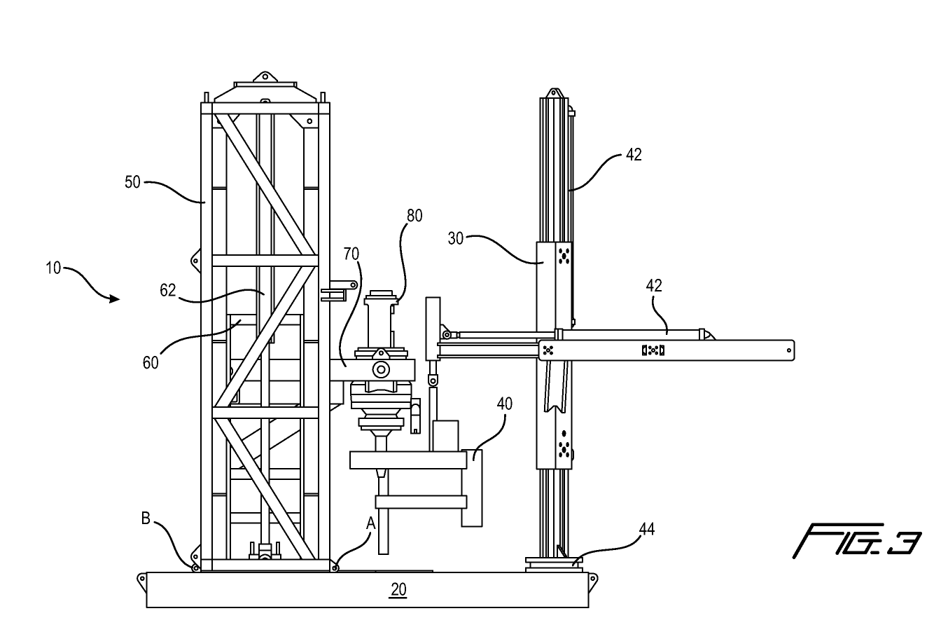

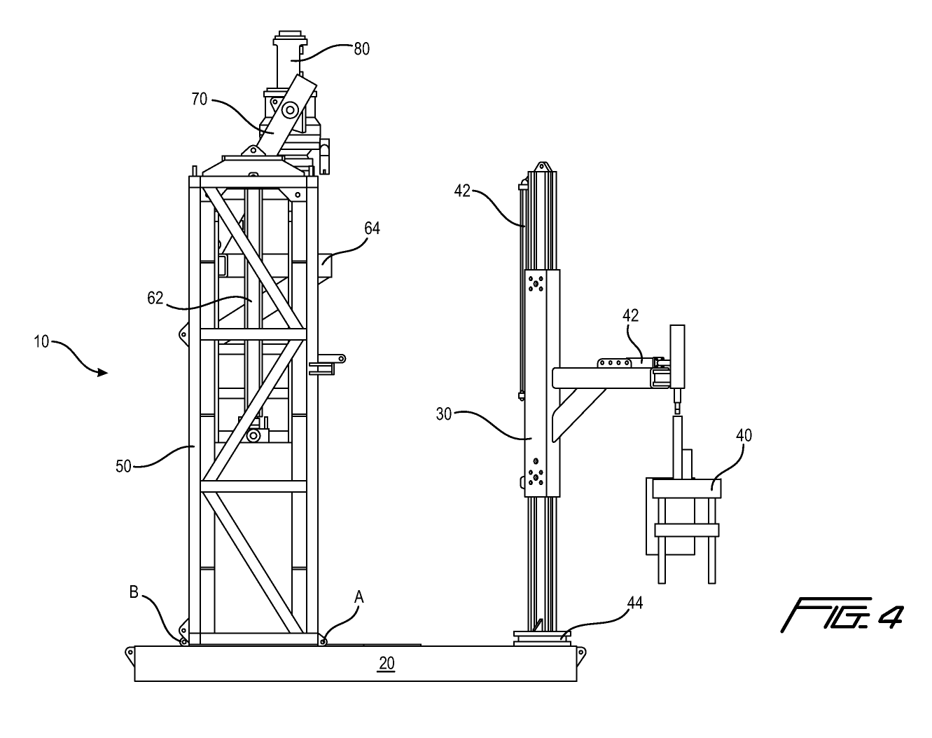

### DETAILED DESCRIPTION OF THE PRESENTLY PREFERRED EMBODIMENT(S)

While various embodiments of the apparatus are possible and contemplated within the scope of this invention, the presently preferred embodiment(s) can be described in conjunction with the drawings.

The power swivel stand having pivoting positioning arms, denoted herein as power swivel stand 10, comprises a base 20, which may be rectangular in shape. A power tong support 30 is provided, typically near one corner of base 20. Power tong 40 is suspended from power tong support 30, which is preferably manually rotatable on bearing assembly 44. Hydraulic cylinders 42 enable moving power tong 40 horizontally and vertically.

Frame 50 is fixed to base 20, preferably by two pinned connections A and B as can be seen. As such, frame 50 cannot move with respect to base 20, save for rotation of frame 50 with respect to base 20 when pins inserted at A and B are removed. This rotatable feature enables frame 50 to lay down on base 20, as later described. Frame 50 cannot slide or otherwise move horizontally with respect to base 20. In other embodiments, frame 50 may be fixed by welding, bolting, etc. to base 20.

Positioned preferably within frame 50 and vertically movable thereon is carriage 60. A means for vertically positioning carriage 60 is provided. In one embodiment, the means for vertically positioning carriage 60 comprises one or more hydraulic cylinders 62, which are substantially vertically oriented, and connect carriage 60 to frame 50. By extending and retracting hydraulic cylinders 62, carriage 60 can be moved vertically on frame 50.

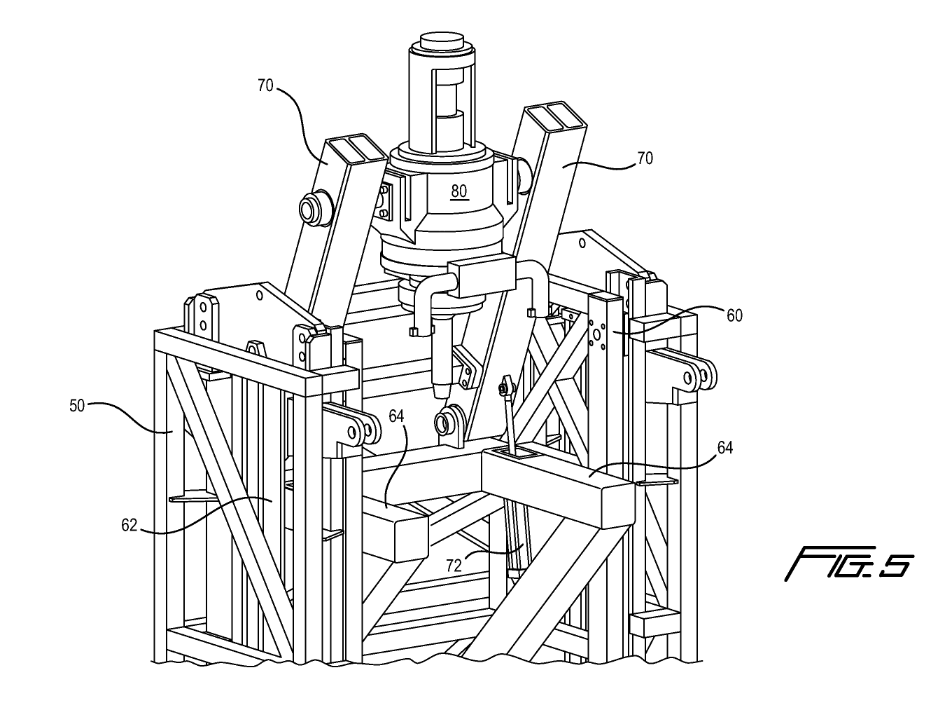

A means for horizontally positioning the power swivel 80 without horizontal movement of frame 50 with respect to base 20 is provided. In a presently preferred embodiment, said means may comprise a plurality of positioning arms pivotally mounted to carriage 60. As can be seen in the drawings, positioning arms 70 are pivotally attached to carriage 60, so as to be capable of pivoting thereon in a generally vertical plane. A means for pivoting positioning arms 70 is provided; in one presently preferred embodiment, the means for pivoting positioning arms 70 may comprise hydraulic cylinders 72 (only one of which is visible) connecting carriage 50 and positioning arms 70, as can be seen in FIG. 5. Extension and retraction of hydraulic cylinders 72 pivots positioning arms 70 with respect to carriage 60. Preferably, carriage 60 includes supports 64 on which positioning arms 70 rest when in their rotated-downward position. While a pair of positioning arms is shown, it is understood that other embodiments could employ a different number of positioning arms. In other embodiments, the means for pivoting positioning arms 70 may comprise one or more motors having a rotating shaft, such as hydraulic motors, connected to the positioning arms, such that rotation of the motor shaft in turn pivots the positioning arms.

Power swivel 80 is connected to positioning arms 70 in such manner that power swivel 60 swivels on positioning arms 70, so that power swivel 80 may remain substantially vertically oriented at all times. This is achieved by the weight of power swivel 80 maintaining the vertical orientation. Such mounting may be by an arm/bushing arrangement or other suitable means.

It is understood that hydraulic lines, hydraulic fluid supplies, controls, etc. as well known in the relevant art are provided to operate the various components of the apparatus.

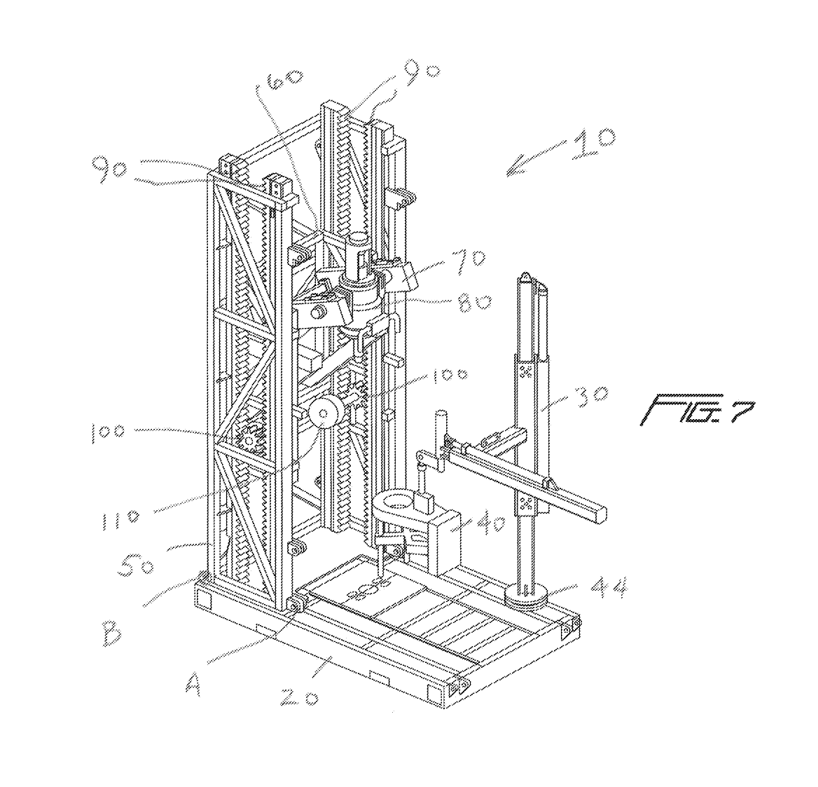

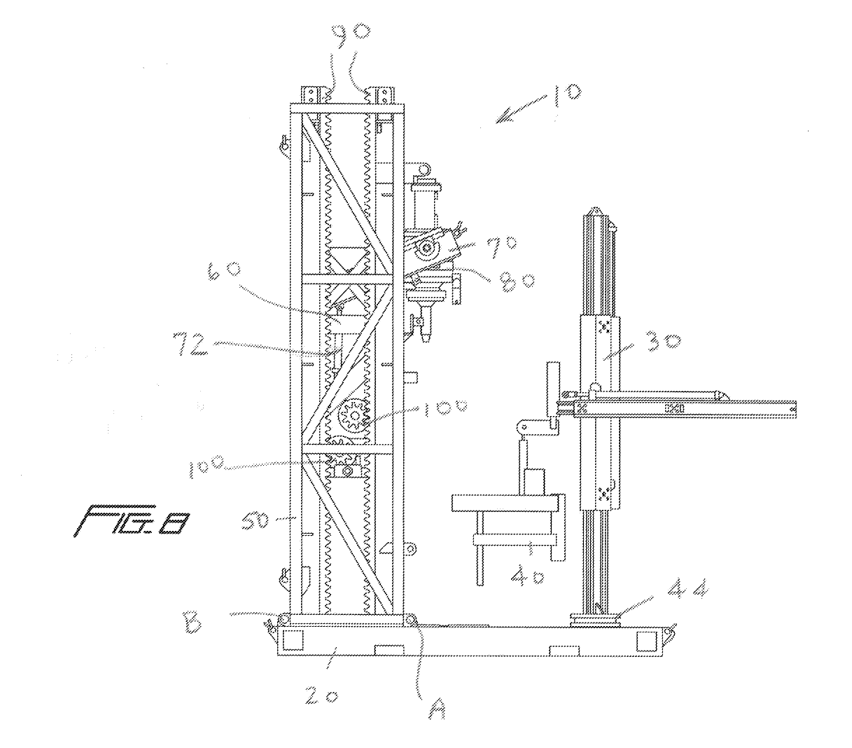

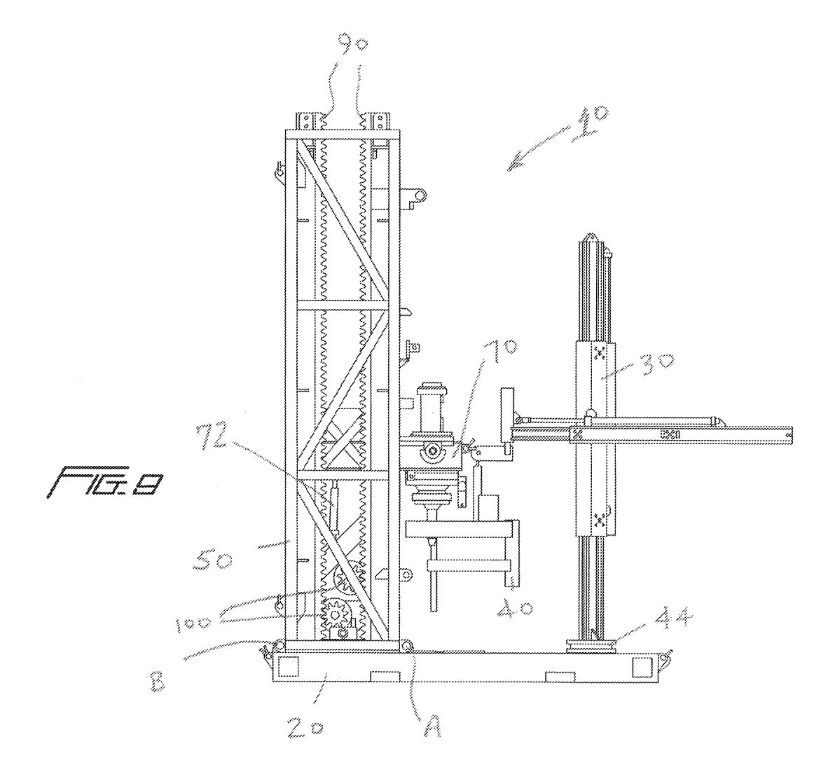

In another embodiment of the power swivel stand, the means for vertically positioning carriage 60 comprises uses a rack and pinion gear arrangement. In the pictured embodiment, FIGS. 7-9, a pair of rack gears 90 are mounted on each side of the interior of frame 50. A pair of pinion gears 100 are mounted on each side of carriage 60, and mesh with corresponding rack gears 90. A means for rotating pinion gears 100 is provided, which in the presently preferred embodiment comprises hydraulic motors 110. It can be readily understood that rotation of pinion gears 100 moves carriage 60 upward and downward.

Various changes are possible to the embodiment shown in FIGS. 7-9. For example, the rack gears could be mounted on the carriage, with the pinion gears and the means for rotating the pinion gears mounted on the frame, and hence stationary thereon. Only a single rack and mating pinion gear could be mounted on either side of carriage 60, thus requiring only two racks and two pinions. Other numbers of pinion gears are possible, e.g. more than four. The means for rotating pinion gears 100 could be electrical or pneumatic motors, in addition to hydraulic motors (element 110, as shown in the figures).

In yet another embodiment of the present invention, the means for vertically positioning carriage 60 may comprise a lead screw and nut arrangement to provide vertical movement of the carriage (and consequently the positioning arms, power swivel, etc.). As is well known in the art, a nut (or collar) is disposed around the lead screw, such that rotation of the lead screw results in linear movement of the nut. In the present application, the lead screw may be mounted on the frame, and the nut or collar mounted on the carriage. Rotation of the lead screw by a hydraulic motor or similar rotary means results in vertical movement of the carriage.

### Setup and Operation of the Apparatus

Further aspects of the structure of the power swivel stand will be explained in conjunction with an explanation of the operation of the apparatus, in a typical work sequence.

The power swivel stand 10 is initially in a “collapsed” position, with frame 50 rotated so as to rest on base 20. This makes the unit compact and easy to handle. Power swivel stand 10 is placed on a platform, and positioned over a well to be worked on. Once in position, frame 50 is rotated upwardly to its vertical position, and pinned in place on base 20. The unit is positioned over a well such that when positioning arms 70 are in their fully downward position, power swivel 80 is oriented vertically over the well to be worked on. Carriage 60 is moved vertically (by the means for vertically positioning carriage 60, namely hydraulic cylinders 62) to in turn move power swivel vertically as needed, to run tubular drillstring, rotate same, cut casing, etc.

Power tongs 40 are positioned over the well as needed, via power tong support 30 (which may be manually rotated on base 44), and hydraulic cylinders 42, to make/break tubular connections.

As can be seen in the drawings, when pivoting positioning arms 70 are in their fully upright position, power swivel 80 is moved out of vertical orientation with well. This movement clears a vertical workspace over the well.

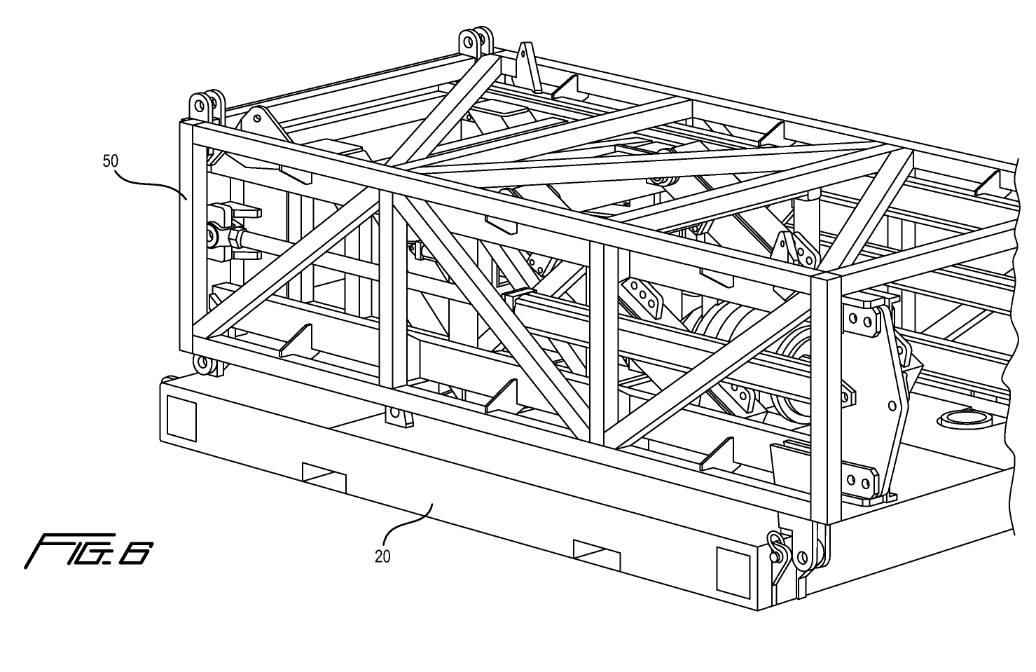

Once work is completed on a well, power swivel stand 10 is generally folded onto base 20. Power tong 40 and power tong support 30 are generally removed from base 20, and one side of frame 50 is unpinned from base 20, and frame 50 (carrying with it carriage 60 and power swivel 80) is rotated downward onto base 20, as can be seen in FIG. 6. Once in this collapsed, compact position, the entire unit can be readily moved via crane, air tugger, etc. to position it over another well, and the operational sequence repeated as described above.

After casing strings in a well have been cut, typically the unit moved off or out of way, and a casing jack or similar apparatus used to extract the cut-off casing string sections.

### Materials

Various types of metal components, particularly high strength structural steel members, would preferably be used to fabricate many of the structural elements of the apparatus. Hydraulic cylinders, controls, commercially available power swivels and power tongs, etc., all as known to those having ordinary skill in the relevant art field, could be used for the other components of the apparatus.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof. For example, dimensions and materials can be changed to suit particular situations; the tool can be used to run various downhole tools in addition to or in lieu of casing cutters, etc.

Therefore, the scope of the invention is not to be limited to the illustrative examples set forth above, but encompasses modifications which may become apparent to those of ordinary skill in the relevant art; the scope of the invention is to be limited only by the appended claims and their legal equivalents.

I claim:

1. A power swivel stand, comprising:
a base;
a frame attached to said base, such that said frame cannot move horizontally with respect to said base;
a carriage disposed on said frame;
a means for vertically positioning said carriage on said frame;
one or more positioning arms pivotally attached to said carriage, said positioning arms adapted to hold a power swivel; and
a means for pivoting said positioning arms.

2. The power swivel stand of claim 1, wherein said means for vertically positioning said carriage comprises one or more vertically disposed hydraulic cylinders.

3. The power swivel stand of claim 1, wherein said means for vertically positioning said carriage comprises a rack and pinion gear assembly.

4. The power swivel stand of claim 1, wherein said means for vertically positioning said carriage comprises a lead screw and nut assembly.

5. The power swivel stand of claim 1, wherein said means for pivoting said positioning arms comprises one or more hydraulic cylinders connecting said positioning arms and said carriage.

6. The power swivel stand of claim 1, wherein said means for pivoting said positioning arms comprises a rotary drive means connected to said positioning arms.

7. The power swivel stand of claim 2, wherein said means for vertically positioning said carriage comprises one or more vertically disposed hydraulic cylinders.

8. The power swivel stand of claim 3, wherein said means for vertically positioning said carriage comprises one or more vertically disposed hydraulic cylinders.

9. The power swivel stand of claim 1, further comprising a power swivel carried by said positioning arms.

10. The power swivel stand of claim 1, wherein said frame is attached to said base by pinned connections.

11. A power swivel stand, comprising:
a base;
a frame attached to said base, such that said frame cannot move horizontally with respect to said base;
a carriage disposed on said frame and vertically positionable thereon;
a means for horizontally positioning a power swivel carried by said carriage, without horizontal movement of said frame with respect to said base.

12. The power swivel stand of claim 11, wherein said means for horizontally positioning a power swivel carried by said carriage comprises one or more positioning arms pivotally connected to said carriage, said positioning arms adapted to hold a power swivel, and a means for pivoting said positioning arms.

13. The power swivel stand of claim 12, wherein said means for pivoting said positioning arms comprises one or more hydraulic cylinders connecting said positioning arms and said carriage.

14. The power swivel stand of claim 12, wherein said means for pivoting said positioning arms comprises a rotary drive means connected to said positioning arms.

15. A method of positioning a power swivel vertically over a well to be serviced, comprising the steps of:
positioning a base proximal said well, said base comprising a frame which is horizontally fixed with respect to said base, said frame supporting a carriage which in turn supports said power swivel, and
moving said power swivel into and out of vertical alignment with said well without moving said frame.

16. The method of claim 15, wherein the step of moving said power swivel into and out of vertical alignment with said well without moving said frame is accomplished by pivoting one or more positioning arms attached to said carriage and supporting said power swivel.
